(19) United States
(12) Patent Application Publication
(10) Pub. No.: US 2026/0292712 A1
(43) Pub. Date: Sep. 24, 2026

(54) METHOD AND APPARATUS FOR POWER HEADROOM REPORT IN MOBILE COMMUNICATIONS

(71) Applicant: MEDIATEK INC., Hsinchu City (TW)

(72) Inventors: Yi-Ru CHEN, Hsinchu City (TW); Cheng-Rung TSAI, Hsinchu City (TW)

(21) Appl. No.: 19/472,655

(22) PCT Filed: Jun. 28, 2024
(86) PCT No.: PCT/CN2024/102203

§ 371 Date: Oct. 4, 2025

Related U.S. Application Data
(60) Provisional application No. 63/516,195, filed on Jul. 28, 2023.

(51) Int. Cl. H04W 52/36; H04L 5/00; H04W 52/14

(52) U.S. Cl. CPC H04W 52/365; H04L 5/0048; H04L 5/0053; H04W 52/146

(57) ABSTRACT

Various solutions for power headroom report (PHR) for multiple transmission reception points (MTRP) operation with respect to user equipment and network apparatus in mobile communications are described. An apparatus may receive a configuration of a two PHR mode and two sounding reference signal (SRS) resource sets from a network node. The apparatus may determine a first PHR for a first physical uplink shared channel (PUSCH) transmission associated with one SRS resource set. The apparatus may determine a second PHR for a second PUSCH transmission associated with the other SRS resource set. The apparatus may transmit the first PHR and the second PHR to the network node.

### CROSS REFERENCE TO RELATED PATENT APPLICATION(S)

The present disclosure is part of a non-provisional application claiming the priority benefit of U.S. Patent Application No. 63/516,195, filed 28 Jul. 2023, the content of which herein being incorporated by reference in its entirety.

### TECHNICAL FIELD

The present disclosure is generally related to mobile communications and, more particularly, to power headroom report (PHR) for multiple transmission reception points (MTRP) operation with respect to user equipment (UE) and network apparatus in mobile communications.

### BACKGROUND

Unless otherwise indicated herein, approaches described in this section are not prior art to the claims listed below and are not admitted as prior art by inclusion in this section.

The UE power headroom report (PHR) is used to report the power headroom available in the UE. The PHR can be configured either for a periodic report or when the downlink path loss changes by a specific amount. For example, the UE may measure a path loss reference signal to determine whether a change of path loss is greater than a threshold value. If yes, the UE may be configured to trigger a power headroom reporting to the network node.

The types of UE power headroom reports are the following. A Type 1 UE power headroom PH that is valid for physical uplink shared channel (PUSCH) transmission occasion i on active uplink (UL) bandwidth part (BWP) b of carrier f of serving cell c. A Type 3 UE power headroom PH that is valid for sounding reference signal (SRS) transmission occasion i on active UL BWP b of carrier f of serving cell c. PHR can be actual or virtual depending on whether there is an actual PUSCH transmission when the UE reports the power headroom. For actual PHR, the power headroom is determined based on an actual PUSCH transmission. For virtual PHR, the power headroom is determined based on a reference PUSCH transmission.

In New Radio (NR), multiple transmission and reception points (multi-TRPs) is introduced to improve reliability, coverage and capacity performance through flexible deployment scenarios. In MTRP operation, two PHR modes may be configured in which one report may contain two PH reports corresponding to different TRPs. In addition, one or more transmission configuration indicator (TCI) state may be indicated for the multi-TRPs.

In current PHR framework for MTRP operation, the UE is configured to calculates virtual PHR based on some default values. However, such configuration does not consider the information indicated in the TCI state for the multi-TRPs. The reported virtual PHR cannot reflect proper UE transmission power. The current PHR determination schemes are not accurate enough for MTRP operation with indicated TCI states.

It is desired for the UE to determine power headroom more dynamic and accurate. Accordingly, how to improve PHR becomes an important issue in the newly developed wireless communication network. Therefore, there is a need to provide proper schemes to determine PHR for MTRP operation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to PHR for MTPR operation with respect to user equipment and network apparatus in mobile communications.

In one aspect, a method may involve an apparatus receiving a configuration of a two PHR mode and two SRS resource sets from a network node. The method may also involve the apparatus determining a first PHR for a first PUSCH transmission associated with one SRS resource set. The method may further involve the apparatus determining a second PHR for a second PUSCH transmission associated with the other SRS resource set. The method may further involve the apparatus transmitting the first PHR and the second PHR to the network node.

In one aspect, a method may involve an apparatus receiving a configuration of a two PHR mode, two SRS resource sets, a first indicated TCI state, a second indicated TCI state and a multi-panel scheme from a network node. The method may also involve the apparatus determining a first PHR associated with the first indicated TCI state for a first PUSCH transmission. The method may further involve the apparatus determining a second PHR associated with the second indicated TCI state for a second PUSCH transmission. The method may further involve the apparatus transmitting the first PHR and the second PHR to the network node.

In one aspect, an apparatus may comprise a transceiver which, during operation, wirelessly communicates with at least one network node. The apparatus may also comprise a processor communicatively coupled to the transceiver. The processor, during operation, may perform operations comprising receiving, via the transceiver, a configuration of a two PHR mode and two SRS resource sets from the network node. The processor may also perform operations comprising determining a first PHR for a first PUSCH transmission associated with one SRS resource set. The processor may further perform operations comprising determining a second PHR for a second PUSCH transmission associated with the other SRS resource set. The processor may further perform operations comprising transmitting, via the transceiver, the first PHR and the second PHR to the network node.

In one aspect, an apparatus may comprise a transceiver which, during operation, wirelessly communicates with at least one network node. The apparatus may also comprise a processor communicatively coupled to the transceiver. The processor, during operation, may perform operations comprising receiving, via the transceiver, a configuration of a two PHR mode, two SRS resource sets, a first indicated TCI state, a second indicated TCI state and a multi-panel scheme from the network node. The processor may also perform operations comprising determining a first PHR associated with the first indicated TCI state for a first PUSCH transmission and a second PHR associated with the second indicated TCI state for a second PUSCH transmission. The processor may further perform operations comprising transmitting, via the transceiver, the first PHR and the second PHR to the network node.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2 is a diagram depicting example scenarios under schemes in accordance with implementations of the present disclosure.

FIG. 3 is a diagram depicting an example MTPR framework under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to PHR for MTRP operation with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

Power headroom may indicate how much transmission power left for a UE to use in addition to the power being used by current transmission. It plays a crucial role in the effective management of uplink transmission power and resource allocation within the network. Basically, it can be described by a simple formula as following.

Power Headroom=UE Maximum Transmission Power−PUSCH Power

The UE may report the calculated power headroom to the network using the Power Headroom Report (PHR), allowing the network to adjust the UE's power control and optimize resource allocation. PHR may be used for UE power control, interference suppression, transmit/receive (TX/RX) setting, and/or network configurations.

To be more specific, PHR can be actual or virtual, depending on whether there is an actual PUSCH transmission when the UE reports the power headroom. Whether to report actual or virtual PHR is based on the scheduling information for an uplink transmission. For actual PHR, the power headroom is determined based on an actual PUSCH transmission. For virtual PHR, the power headroom is determined based on a reference PUSCH transmission (e.g., an estimated/calculated power without an actual PUSCH transmission). For example, for uplink transmissions whose scheduling information are configured, an actual PHR will be reported. If there is no uplink transmission on a serving cell/carrier, a virtual PHR will be reported.

If a UE determines that a Type 1 power headroom report for an activated serving cell is based on an actual PUSCH transmission then, for PUSCH transmission occasion i on active UL BWP b of carrier f of serving cell c, the UE computes the Type 1 power headroom report as following.

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

P_{CMAX,f,c}(i), P_{O_PUSCH,b,f,c}(j),

$${M}_{RB , b , f , c}^{PUSCH} ( i ) ,$$

α_{b,f,c}(j), P_{Lb,f,c}(q_{d}), ΔT_{F,b,f,c}(i) and f_{b,f,c}(i, l) are defined in 3rd Generation Partnership Project (3GPP) Technical Specification. Δ_{TF,b,f,c}(i) is a power adjustment of the PUSCH transmission in PUSCH transmission occasion i. P_{CMAX,f,c}(i) is the UE configured maximum output power for carrier f of serving cell c in PUSCH transmission occasion i. P_{O_PUSCH,b,f,c}(j) is a parameter composed of the sum of a component P_{O_NOMINAL,PUSCH,f,c}(j) and a component P_{O_UE_PUSCH,b,f,c}(j) where these two components are provided by the network or pre-defined, and j∈{0, 1, . . . , J−1}, α_{b,f,c}(j) is configured by the network or pre-defined.

$${M}_{RB , b , f , c}^{PUSCH} ( i )$$

is a bandwidth of the PUSCH resource assignment expressed in number of resource blocks for PUSCH transmission occasion i on active UL BWP b of carrier f of serving cell c and u is a SCS configuration. PL_{b,f,c}(q_{d}) is a downlink pathloss estimate in dB calculated by the UE using reference signal (RS) index q_{d} for the active DL BWP of carrier f of serving cell c. f_{b,f,c}(i, l) is the PUSCH power control adjustment state l for active UL BWP b of carrier f of serving cell c in PUSCH transmission occasion i.

If the UE determines that a Type 1 power headroom report for an activated serving cell is based on a reference PUSCH transmission then, for PUSCH transmission occasion i on active UL BWP b of carrier f of serving cell c, the UE computes the Type 1 power headroom report as following.

$${PH}_{type 1 , b , f , c} ( i , j , {q}_{d} , l ) = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

\tilde{P}_{CMAX,f,c}(i) is computed assuming MPR=0 dB, A-MPR=0 dB, P-MPR=0 dB and DTC=0 dB. MPR, A-MPR, P-MPR and DTC are defined in [8-1, TS 38.101-1], [8-2, TS 38.101-2] and [8-3, TS 38.101-3] and other parameters are defined in 3GPP TS. In addition, in determining the virtual PHR (i.e., PHR based on a reference PUSCH transmission), some parameters are determined based on default values. For example, P_{O_PUSCH,b,f,c}(j) and α_{b,f,c}(j) are obtained using P_{O_NOMINAL,PUSCH,f,c}(0) and p0-PUSCH-AlphaSetId=0. PL_{b,f,c}(q_{d}) is obtained using pusch-PathlossReferenceRS-Id=0. These values do not consider the latest power control information for a TRP. The determined virtual PHR may not reflect real UE transmission power. Therefore, the power control between the UE and the network node could be inaccurate and inefficient.

For an MTRP operation, the UE may be configured a two PHR mode to report multiple PHs for multiple TRPs. The two PHR mode means that one report may contain two PHs corresponding to different SRS resource sets. Each SRS resource set may associate with a TRP. The UE may determine one PH for one TRP respectively. The UE may include the two PHs in one report and transmit the report including two PHs to the network side via Medium Access Control (MAC) Control Element (CE). The network side may access the two PHs and distribute to the corresponding TRPs.

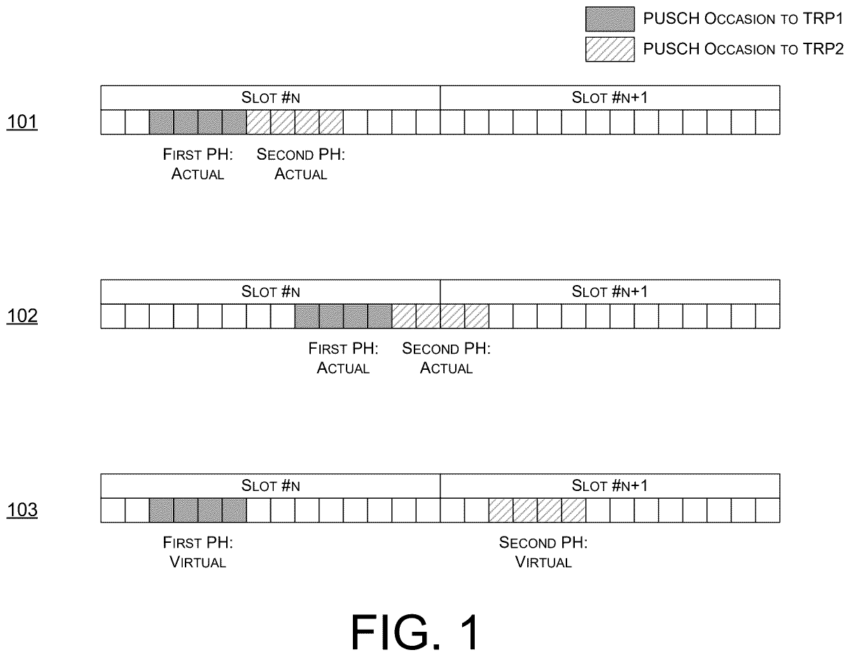

For an MTRP operation, it is supported that the UE may transmit multiple PUSCH transmissions with identical contents (e.g., PUSCH repetitions) to multiple TRPs. Multiple PHs associated with multiple TRPs may be determined and reported. How to determine the multiple PHs may depend on uplink transmission occasion associated with the multiple-TRP (M-TRP). FIG. 1 illustrates example scenarios 101-103 under schemes in accordance with implementations of the present disclosure. Scenarios 101-103 involve at least a UE and two network nodes (e.g., two TRPs), which may be a part of a wireless communication network (e.g., an LTE network, a 5G/NR network, an IoT network or a 6G network). Scenarios 101-103 illustrate examples for determining two PHs associated with two TRPs. The UE May be scheduled a first PUSCH occasion (e.g., PUSCH occasion to TRP1) and a second PUSCH occasion (e.g., PUSCH occasion to TRP2). The UE may determine the PH based on whether these is an actual PUSCH transmission on the PUSCH occasion.

If these is actual repetition(s) among M-TRP PUSCH repetitions in slot #n, the UE provides the first PHR for the PUSCH repetition starting earliest in slot #n (i.e., actual PHR), where the PUSCH repetition is associated with one SRS resource set (e.g., TRP1). If there is another actual PUSCH repetition(s) associated with the other SRS resource set (e.g., TRP2) in slot #n, the UE provides the second PHR for the first PUSCH repetition associated with the other SRS resource set in slot #n (i.e., actual PHR) (scenario 101). If there is no PUSCH repetition associated with the other SRS resource set (e.g., TRP2) in slot #n, the UE provides the second PHR for a reference PUSCH transmission (i.e., virtual PHR) (scenario 102). If there is no actual repetition among M-TRP PUSCH repetitions in slot #n, the UE provides the two PHRs for two reference PUSCH transmissions (i.e., two virtual PHRs) (scenario 103).

The PHR may be determined based on uplink transmission(s) within one slot. Since UE power control may be different in different slots, the PHR can be determined per slot. Specifically, the UE may determine the PHR based on the starting symbol of PUSCH transmission. In scenario 101, the two PUSCH occasions are scheduled within slot #n, the UE should determine the PHR based on both of the two PUSCH occasions. For example, the UE may determine that the first PH is actual and the second PH is actual. In scenario 102, although part of the second PUSCH occasion is in slot #n+1, the UE should determine the PHR based on both of the two PUSCH occasions since the starting symbol of the second PUSCH occasion is within slot #n. For example, the UE may determine that the first PH is actual and the second PH is actual. In scenario 103, the two PUSCH occasions are scheduled within different slots (e.g., slot #n and slot #n+1), the UE should determine the PHR based on one PUSCH occasion in the slot. For example, the UE may determine that the first PH is virtual and the second PH is virtual.

In the unified TCI state framework, a common beam may be indicated for data and control transmission/reception for downlink (DL) and uplink (UL). For a serving cell configured with joint DL/UL TCI mode (e.g., unifiedTCI-StateType=“joint”), a full-set or any of sub-set of {1st joint TCI state, 2nd joint TCI state} can be mapped to a TCI codepoint of the existing TCI field in a downlink control information (DCI) format 1_1/1_2. For a serving cell configured with separate DL/UL TCI mode (e.g., unifiedTCI-StateType=“separate”), a full-set or any of sub-set of {1st DL TCI state, 1st UL TCI state, 2nd DL TCI state, 2nd UL TCI state} can be mapped to a TCI codepoint of the existing TCI field in a DCI format 1_1/1_2. The TCI state activation command (e.g., MAC-CE) should indicate that each joint/DL/UL TCI state mapped to a TCI codepoint is the first or second joint/DL/UL TCI state.

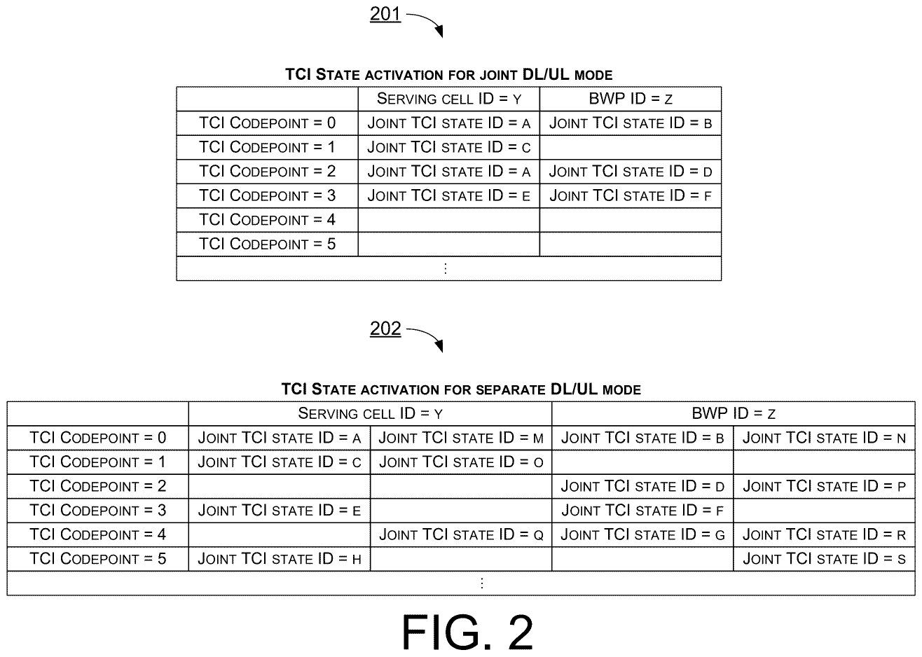

FIG. 2 illustrates example TCI state activation methods under schemes in accordance with implementations of the present disclosure. Table 201 illustrates the TCI state activation for joint DL/UL TCI mode. The “serving cell ID=y” and “BWP ID=z” may be used to indicate which serving cell and BWP should be applied for the TCI state activation command. The TCI state activation command may be used to activate the TCI states corresponding to a first TRP and may be used to activate the TCI states corresponding to a second TRP. Table 202 illustrates the TCI state activation for separate DL/UL TCI mode. The “serving cell ID=y” and “BWP ID=z” may be used to indicate which serving cell and BWP should be applied for the TCI state activation command. The TCI state activation command may be used to activate the DL TCI states and UL TCI states respectively corresponding to a first TRP and may be used to activate the DL TCI states and UL TCI states respectively corresponding to a second TRP.

For TCI state indication via DCI, the TCI field in DCI format 1_1/1_2 may indicate joint/DL/UL TCI state(s) for one TRP or both TRPs. For example, DCI format 1_1/1_2 may indicate a first indicated TCI state(s) for a first TRP and/or a second indicated TCI state(s) for a second TRP. The UE needs to maintain both the first indicated TCI state(s) and the second indicated TCI state(s). The TCI field in the DCI may indicate one TCI codepoint, and the UE may determine the corresponding TCI state(s) from the TCI state(s) mapped to the indicated TCI codepoint according to MAC-CE TCI state activation. If there is only one TCI codepoint is mapped with TCI state(s), the TCI codepoint may be “indicated” after MAC-CE takes effect without DCI indication. If the UE receives a beam indication DCI that indicates TCI state(s) only for one TRP, the UE shall update the indicated TCI state(s) for the TRP and keep the current indicated TCI state(s) for another TRP.

In view of the above, the present disclosure proposes some schemes pertaining to PHR determination for MTRP operation with respect to UE and network apparatus in mobile communications. According to the schemes of the present disclosure, when determining PHs for multiple-TRPs, the UE needs to consider some UL power control parameters in the indicated TCI state. Different TRPs may associated with different indicated TCI states, the UE also needs to maintain multiple indicated TCI states for different TRPs. The UE may use the latest UL power control parameters provided in the indicated TCI state to determine the virtual PHR. Accordingly, the UE power headroom can be accurately reported to reflect proper/real UE transmit power. The UE power control can be improved.

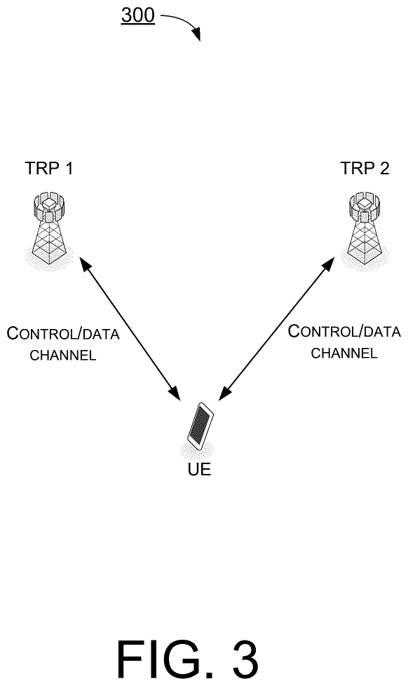

FIG. 3 illustrates an example scenario 300 under schemes in accordance with implementations of the present disclosure. Scenario 300 involves at least a UE, and multiple network nodes (e.g., TRPs), which may be a part of a wireless communication network (e.g., an LTE network, a 5G/NR network, an IoT network or a 6G network). Scenario 300 illustrates the framework of MTRP operation in a communication system. The UE may establish connections with the first TRP (e.g., TRP 301) and the second TRP (e.g., TRP 302). The UE is able to receive/transmit control signal and data from/to at least one of the first TRP and the second TRP.

Specifically, the UE may be provided by higher layer configurations (e.g., radio resource control (RRC) configuration) from the network node with at least one configuration of a two PHR mode and two SRS resource sets with usage set to codebook based or non-codebook based (e.g., “codebook” or “nonCodebook”) transmission. One SRS resource set may correspond to one TRP. The UE may perform the MTRP operation according to the configured multiple SRS resource sets. The UE may be configured to provide two Type 1 power headroom reports in a slot n. The UE may determine a first PHR based on an actual PUSCH transmission in an event that the first PHR is determined for an actual PUSCH repetition of a PUSCH transmission associated with one SRS resource set (e.g., actual PHR). The first PUSCH transmission may be an actual PUSCH repetition associated with one SRS resource set starting earliest in a slot, and no PUSCH repetition associated with the other SRS resource set may be transmitted by the apparatus in the slot. For example, the UE may provide a first Type 1 PHR for an actual PUSCH repetition of a PUSCH transmission starting earliest in slot n that is associated with one SRS resource set. The UE may determine a second PHR based on an actual PUSCH transmission in an event that the second PHR is determined for an actual PUSCH repetition associated with the other SRS resource set (e.g., actual PHR). The first PHR may be determined for the actual PUSCH repetition starting earliest in a slot n, and the second PHR may be determined for the actual PUSCH repetition overlapping with the slot n. For example, if the UE transmits PUSCH repetitions associated with the other SRS resource set in slot n, the UE may provide a second Type 1 PHR for a first actual PUSCH repetition associated with the other SRS resource set that overlaps with slot n.

The UE may determine a second PHR based on at least one parameter in an TCI state in an event that the second PHR is determined for a reference PUSCH transmission associated with the other SRS resource set (e.g., virtual PHR). The indicated TCI state may comprise a first indicated TCI state. The UE may determine the second PHR based on at least one power control parameter and a pathloss reference signal associated with the first indicated TCI state in an event that the other SRS resource set is a first SRS resource set. Alternatively, the indicated TCI state may comprise a second indicated TCI state. The UE may determine the second PHR based on at least one power control parameter and a pathloss reference signal associated with the second indicated TCI state in an event that the other SRS resource set is a second SRS resource set. For example, the UE may provide a second Type 1 PHR for a reference PUSCH transmission associated with the other SRS resource set. If the other SRS resource set is the first SRS resource set and the UE is provided d1-OrJointTCI-StateList or TCI-UL-State having a first indicated TCI state and a second indicated TCI state, the UE may provide a second Type 1 PHR based on p0AlphaSetforPUSCH and PL-RS associated with the first indicated TCI state. If the other SRS resource set is the second SRS resource set and the UE is provided d1-OrJointTCI-StateList or TCI-UL-State having a first indicated TCI state and a second indicated TCI state, the UE may provide a second Type 1 PHR based on p0AlphaSetforPUSCH and PL-RS associated with the second indicated TCI state.

In some implementations, the indicated TCI state comprises a first indicated TCI state and a second indicated TCI state. The UE may determine the first PHR based on at least on power control parameter and a pathloss reference signal associated with the first indicated TCI state in an event that the first PHR is determined for a reference PUSCH transmission associated a first SRS resource set (e.g., virtual PHR). The UE may determine the second PHR based on at least on power control parameter and a pathloss reference signal associated with the second indicated TCI state in an event that the second PHR is determined for a reference PUSCH transmission associated a second SRS resource set (e.g., virtual PHR). For example, the UE may provide a Type 1 PHR for a reference PUSCH transmission associated with the first SRS resource set and provide a Type 1 PHR for a reference PUSCH transmission associated with the second SRS resource set. If the UE is provided d1-OrJointTCI-StateList or TCI-UL-State having a first indicated TCI state and a second indicated TCI state, the UE may provide a first Type 1 PHR based on p0AlphaSetforPUSCH and PL-RS associated with the first indicated TCI state and provide a second Type 1 PHR based on p0AlphaSetforPUSCH and PL-RS associated with the second indicated TCI state.

After determining the first PHR and/or the second PHR, the UE may be configured to transmit at least one of the first PHR and the second PHR to the network node.

In some implementations, if a UE is provided twoPHRMode, and is provided two SRS resource sets in srs-ResourceSetToAddModList or srs-ResourceSetToAddModListDCI-0-2 with usage set to ‘codebook’ or ‘nonCodebook’ on active UL BWP b of carrier f of serving cell c, the UE provides two Type 1 power headroom reports in a slot n, where:
if the UE provides a first Type 1 power headroom report for an actual PUSCH repetition of a PUSCH transmission starting earliest in slot n that is associated with one SRS resource set;
if the UE transmits PUSCH repetitions associated with the other SRS resource set in slot n, the UE provides a second Type 1 power headroom report for a first actual PUSCH repetition associated with the other SRS resource set that overlaps with slot n;
else, the UE provides a second Type 1 power headroom report for a reference PUSCH transmission associated with the other SRS resource set, where:
if the other SRS resource set is the first SRS resource set, P_{O_PUSCH,b,f,c}(j) and α_{b,f,c}(j) are obtained using P_{O_NOMINAL,PUSCH,f,c}(0) and p0-PUSCH-AlphaSetId=0, PL_{b,f,c}(q_{d}) is obtained using pusch-PathlossReferenceRS-Id=0 if the UE is not provided enablePL-RS-UpdateForPUSCH-SRS or is obtained from PUSCH-PathlossReferenceRS-Id mapped to sri-PUSCH-PowerControlId=0 of sri-PUSCH-MappingToAddModList if the UE is provided enablePL-RS-UpdateForPUSCH-SRS, and I=0; if the UE is provided d1-OrJointTCI-StateList or TCI-UL-State that indicate a first TCI-State or TCI-UL-State and a second TCI-State or TCI-UL-State, the UE provides the second Type 1 power headroom report using the p0AlphaSetforPUSCH and pathlossReferenceRS-Id-r17 values associated with the first TCI-State or TCI-UL-State;
else, P_{O_PUSCH,b,f,c}(j) and α_{b,f,c}(j) are obtained using P_{O_NOMINAL,PUSCH,f,c}(0) and p0-PUSCH-AlphaSetId=1, PL_{b,f,c}(q_{d}) is obtained using pusch-PathlossReferenceRS-Id=1 if the UE is not provided enablePL-RS-UpdateForPUSCH-SRS or is obtained from PUSCH-PathlossReferenceRS-Id mapped to sri-PUSCH-PowerControlId=0 of sri-PUSCH-MappingToAddModList2 if the UE is provided enablePL-RS-UpdateForPUSCH-SRS, and l=1 if the UE is provided twoPUSCH-PC-AdjustmentStates, or l=0 if the UE is not provided twoPUSCH-PC-AdjustmentStates; if the UE is provided d1-OrJointTCI-StateList or TCI-UL-State that indicate a first TCI-State or TCI-UL-State and a second TCI-State or TCI-UL-State, the UE provides the second Type 1 power headroom report using the p0AlphaSetforPUSCH and pathlossReferenceRS-Id-r17 values associated with the second TCI-State or TCI-UL-State;
else, if the UE provides a Type 1 power headroom report for a reference PUSCH transmission associated with the first SRS resource set, the UE provides a Type 1 power headroom report for a reference PUSCH transmission associated with the second SRS resource set, where:
for the first Type 1 power headroom report, P_{O_PUSCH,b,f,c}(j) and α_{b,f,c}(j) are obtained using P_{O_NOMINAL,PUSCH,f,c}(0) and p0-PUSCH-AlphaSetId=0, PL_{b,f,c}(a) is obtained using pusch-PathlossReferenceRS-Id=0 if the UE is not provided enablePL-RS-UpdateForPUSCH-SRS, or is obtained from the PUSCH-PathlossReferenceRS-Id mapped to sri-PUSCH-PowerControlId=0 of sri-PUSCH-MappingToAddModList if the UE is provided enablePL-RS-UpdateForPUSCH-SRS, and l=0;
for the second Type 1 power headroom report, P_{O_PUSCH,b,f,c}(j) and α_{b,f,c}(j) are obtained using P_{O_NOMINAL,PUSCH,f,c}(0) and p0-PUSCH-AlphaSetId=1, PL_{b,f,c}(q_{d}) is obtained using pusch-PathlossReferenceRS-Id=1 if the UE is not provided enablePL-RS-UpdateForPUSCH-SRS, or is obtained from the PUSCH-PathlossReferenceRS-Id mapped to sri-PUSCH-PowerControlId=0 of sri-PUSCH-MappingToAddModList2 if the UE is provided enablePL-RS-UpdateForPUSCH-SRS, and I=1 if the UE is provided twoPUSCH-PC-AdjustmentStates or l=0 if the UE is not provided twoPUSCH-PC-AdjustmentStates;
if a UE is provided d1-OrJointTCI-StateList or TCI-UL-State and is indicated a first TCI-State or TCI-UL-State and a second TCI-State or TCI-UL-State, the UE provides the first or the second Type 1 power headroom reports using the p0AlphaSetforPUSCH and pathlossReferenceRS-Id-r17 values associated with the first TCI-State or TCI-UL-State or with the second TCI-State or TCI-UL-State, respectively, if the reference PUSCH transmission is associated with the first TCI-State or TCI-UL-State or with the second TCI-State or TCI-UL-State, respectively.

In another proposed scheme of the present disclosure, the MTRP operation may involve non-repetition PUSCH transmissions. The UE may be configured to transmit different PUSCHs (e.g., different layers of one PUSCH) to different TRPs (i.e., multi-panel simultaneous Tx scheme). The UE may be provided by higher layer configurations (e.g., RRC configuration) from the network node with at least one configuration of a two PHR mode, a, multi-panel scheme, two SRS resource sets with usage set to codebook based or non-codebook based (e.g., “codebook” or “nonCodebook”) transmission, and d1-OrJointTCI-StateList or TCI-UL-State. The UE may be indicated with two TCI states (e.g., a first indicated TCI state and a second indicated TCI state) by MAC-CE or DCI. One SRS resource set may correspond to one TRP. The UE may perform the MTRP operation according to the configured multiple SRS resource sets. The UE may be configured to provide two Type 1 power headroom reports in a slot n.

The UE may determine a first PHR associated with the first indicated TCI state based on an actual PUSCH transmission in an event that the first PHR is determined for an actual PUSCH transmission applying only the first indicated TCI state (e.g., actual PHR). The UE may determine a second PHR associated with the second indicated TCI state based on at least one parameter in the second indicated TCI state in an event that the second PHR is determined for a reference PUSCH transmission (e.g., virtual PHR). For example, the UE may provide a first Type 1 PHR associated with the first indicated TCI state for an actual PUSCH transmission applies only the first indicated TCI state, and the UE may provide a second Type 1 PHR associated with the second indicated TCI state for a reference PUSCH transmission based on p0AlphaSetforPUSCH and PL-RS associated with the second indicated TCI state.

In some implementations, the UE may determine the first PHR associated with the first indicated TCI state based on at least one parameter in the first indicated TCI state in an event that the first PHR is determined for a reference PUSCH transmission (e.g., virtual PHR). The UE may determine the second PHR associated with the second indicated TCI state based on an actual PUSCH transmission in an event that the second PHR is determined for an actual PUSCH transmission applying only the second indicated TCI state (e.g., actual PHR). For example, the UE may provide a second Type 1 PHR associated with the second indicated TCI state for an actual PUSCH transmission applies only the second indicated TCI state, and the UE may provide a first Type 1 PHR associated with the first indicated TCI state for a reference PUSCH transmission based on p0AlphaSetforPUSCH and PL-RS associated with the first indicated TCI state.

In some implementations, the UE may determine the first PHR associated with the first indicated TCI state based on an actual PUSCH transmission in an event that the first PHR is determined for an actual PUSCH transmission applying both the first indicated TCI state and the second indicated TCI state (e.g., actual PHR). The UE may determine the second PHR associated with the second indicated TCI state based on an actual PUSCH transmission in an event that the second PHR is determined for an actual PUSCH transmission applying both the first indicated TCI state and the second indicated TCI state (e.g., actual PHR). For example, the UE may provide a first Type 1 associated with the first indicated TCI state, and the UE may provide a second Type 1 PHR associated with the second indicated TCI state, for an actual PUSCH transmission applies both indicated TCI states.

In some implementations, the UE may determine the first PHR associated with the first indicated TCI state based on at least one parameter in the first indicated TCI state in an event that the first PHR is determined for a first reference PUSCH transmission (e.g., virtual PHR). The UE may determine the second PHR associated with the second indicated TCI state based on at least one parameter in the second indicated TCI state in an event that the second PHR is determined for a second reference PUSCH transmission (e.g., virtual PHR). For example, the UE may provide a first Type 1 PHR associated with the first indicated TCI state for a first reference PUSCH transmission based on p0AlphaSetforPUSCH and PL-RS associated with the first indicated TCI state, and the UE may provide a second Type 1 PHR associated with the second indicated TCI state for a second reference PUSCH transmission based on p0AlphaSetforPUSCH and PL-RS associated with the second indicated TCI state.

After determining the first PHR and/or the second PHR, the UE may be configured to transmit at least one of the first PHR and the second PHR to the network node.

In some implementations, if a UE is provided, for active UL BWP of carrier of serving cell, twoPHRMode, two SRS resource sets in srs-ResourceSetToAddModList or srs-ResourceSetToAddModListDCI-0-2 with usage set to ‘codebook’ or ‘nonCodebook’, d1-OrJointTCI-StateList or TCI-UL-State and is indicated a first TCI-State or TCI-UL-State and a second TCI-State or TCI-UL-State, and multipanelScheme, the UE provides:
a first Type 1 power headroom report and a first configured maximum output power associated with the first TCI-State or TCI-UL-State for an actual PUSCH transmission using a spatial domain filter corresponding only to the first TCI-State or TCI-UL-State, and a second Type 1 power headroom report and a second configured maximum output power associated with the second TCI-State or TCI-UL-State for a reference PUSCH transmission using the p0AlphaSetforPUSCH and pathlossReferenceRS-Id-r17 values associated with the second TCI-State or TCI-UL-State;
a second Type 1 power headroom report and a second configured maximum output power associated with the second TCI-State or TCI-UL-State for an actual PUSCH transmission using a spatial domain filter corresponding only to the second TCI-State or TCI-UL-State, and a first Type 1 power headroom report and a first configured maximum output power associated with the first TCI-State or TCI-UL-State for a reference PUSCH transmission using the p0AlphaSetforPUSCH and pathlossReferenceRS-Id-r17 values associated with the first TCI-State or TCI-UL-State;
a first Type 1 power headroom report and a first configured maximum output power associated with the first TCI-State or TCI-UL-State, and a second Type 1 power headroom report and a second configured maximum output power associated with the second TCI-State or TCI-UL-State, for an actual PUSCH transmission using a spatial domain filter corresponding to the first TCI-State or TCI-UL-State and using a spatial domain filter corresponding to the second TCI-State or TCI-UL-State;
a first Type 1 power headroom report and a first configured maximum output power associated with the first TCI-State or TCI-UL-State for a reference PUSCH transmission using the p0AlphaSetforPUSCH and pathlossReferenceRS-Id-r17 values associated with the first TCI-State or TCI-UL-State, and a second Type 1 power headroom report and a second configured maximum output power associated with the second TCI-State or TCI-UL-State for another reference PUSCH transmission using the p0AlphaSetforPUSCH and pathlossReferenceRS-Id-r17 values associated with the second TCI-State or TCI-UL-State.

In some implementations, for each TCI state, UL power control parameters and path loss-reference signal (PL-RS) may be provided by an RRC configuration. For example, the parameters pathlossReferenceRS-Id-r17 (i.e., PL_{b,f,c}(qₛ)) and u1-powerControl-r17 may be provided in TCI-State of the RRC configuration. u1-powerControl-r17 may comprise p0AlphaSetforPUSCH-r17. POAlphaSet-r17 may comprise p0-r17 (i.e., P_{O_PUSCH,b,f,c}(j)), alpha-r17 (i.e., α_{b,f,c}(j)) and closedLoopIndex-r17 (i.e., f_{b,f,c}(i, l)). These parameters may be used by the UE for determining the virtual PHR.

### Illustrative Implementations

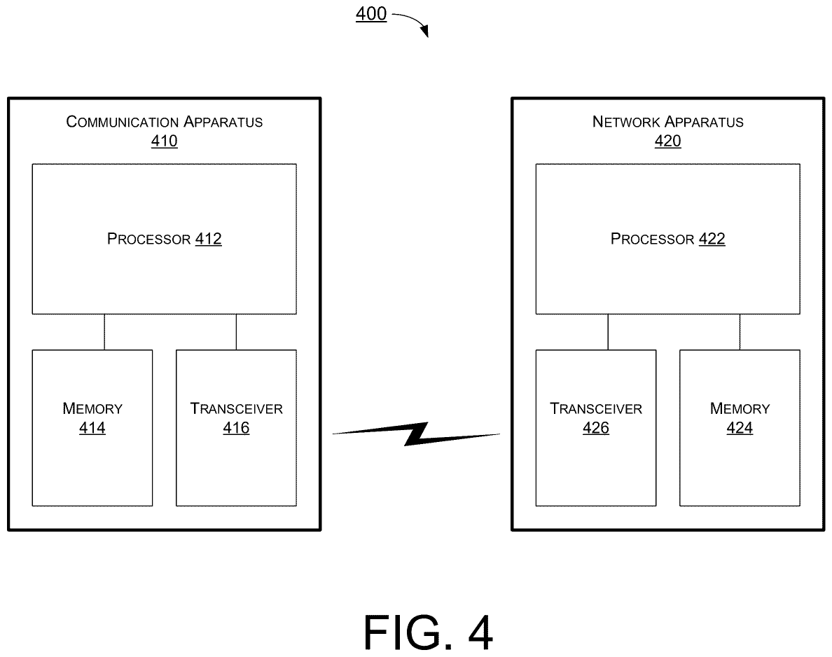

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to PHR for MTRP operation, including scenarios/schemes described above as well as processes 500, 600 and 700 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 410 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed schemes of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a satellite, a BS, a small cell, a router or a gateway of an IoT network. For instance, network apparatus 420 may be implemented in a satellite or an eNB/gNB/TRP in a 4G/5G/B5G/6G, NR, IoT, NB-IoT or IIoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks, including PHR for MTRP operation, in a device (e.g., as represented by communication apparatus 410) and a network node (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, transceiver 416 may be capable of wirelessly communicating with different types of UEs and/or wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, network apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, communication apparatus 410 may further include a memory 414 coupled to processor 412 and capable of being accessed by processor 412 and storing data therein. In some implementations, network apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 410 and network apparatus 420 may be a communication entity capable of communicating with each other using various proposed schemes in accordance with the present disclosure. For illustrative purposes and without limitation, descriptions of capabilities of communication apparatus 410, as a UE, and network apparatus 420, as a network node (e.g., TRP), are provided below with processes 500, 600 and 700.

### Illustrative Processes

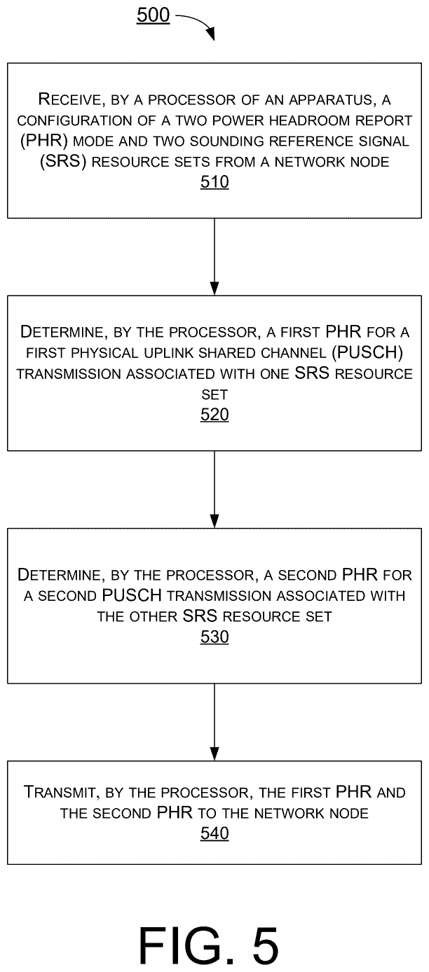

FIG. 5 illustrates an example process 500 under schemes in accordance with an implementation of the present disclosure. Process 500 may represent an aspect of implementing various proposed designs, concepts, schemes, systems and methods described above, whether partially or entirely, including those described above. More specifically, process 500 may represent an aspect of the proposed concepts and schemes pertaining to PHR for MTRP operation in mobile communications. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in communication apparatus 410 as well as any variations thereof. Solely for illustrative purposes and without limiting the scope, process 500 is described below in the context of communication apparatus 410 as a UE and network apparatus 420 as a network node (e.g., TRP). Process 500 may begin at block 510.

At block 510, process 500 may involve processor 412 of communication apparatus 410, implemented in or as a UE, receiving a configuration of a two PHR mode and two SRS resource sets from a network node. Process 500 may proceed from block 510 to block 520.

At block 520, process 500 may involve processor 412 determining a first PHR for a first physical uplink shared channel (PUSCH) transmission associated with one SRS resource set. Process 500 may proceed from block 520 to block 530.

At block 530, process 500 may involve processor 412 determining a second PHR for a second PUSCH transmission associated with the other SRS resource set. Process 500 may proceed from block 530 to block 540.

At block 540, process 500 may involve processor 412 transmitting the first PHR and the second PHR to the network node.

In some implementations, the first PUSCH transmission may be an actual PUSCH repetition associated with one SRS resource set starting earliest in a slot, and no PUSCH repetition associated with the other SRS resource set is transmitted by communication apparatus 410 in the slot.

In some implementations, the second PUSCH transmission may be a reference PUSCH transmission associated with the other SRS resource set. Process 500 may involve processor 412 determining the second PHR based on at least one power control parameter and a pathloss reference signal associated with a first indicated TCI state in an event that the other SRS resource set is a first SRS resource set.

In some implementations, the second PUSCH transmission may be a reference PUSCH transmission associated with the other SRS resource set. Process 500 may involve processor 412 determining the second PHR based on at least one power control parameter and a pathloss reference signal associated with a second indicated TCI state in an event that the other SRS resource set is a second SRS resource set.

In some implementations, the first PUSCH transmission may be a reference PUSCH transmission associated with a first SRS resource set and the second PUSCH transmission may be a reference PUSCH transmission associated with a second SRS resource set. Process 500 may involve processor 412 determining the first PHR for the reference PUSCH transmission associated with the first SRS resource set based on at least on power control parameter and a pathloss reference signal associated with a first indicated TCI state. Process 500 may further involve processor 412 determining the second PHR for the reference PUSCH transmission associated with the second SRS resource set based on at least one power control parameter and a pathloss reference signal associated with a second indicated TCI state.

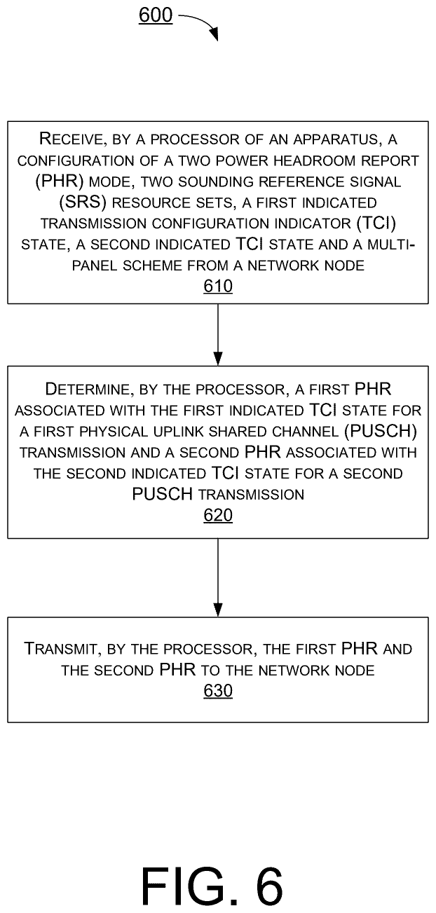

FIG. 6 illustrates an example process 600 under schemes in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to PHR for MTRP operation in mobile communications. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in communication apparatus 410 as well as any variations thereof. Solely for illustrative purposes and without limiting the scope, process 600 is described below in the context of communication apparatus 410 as a UE and network apparatus 420 as a network node (e.g., TRP). Process 600 may begin at block 610.

At block 610, process 600 may involve processor 412 of communication apparatus 410, implemented in or as a UE, receiving a configuration of a two PHR mode, two SRS resource sets, a first indicated TCI state, a second indicated TCI state and a multi-panel scheme from a network node. Process 600 may proceed from block 610 to block 620.

At block 620, process 600 may involve processor 412 determining a first PHR associated with the first indicated TCI state for a first PUSCH transmission and a second PHR associated with the second indicated TCI state for a second PUSCH transmission. Process 600 may proceed from block 620 to block 630.

At block 630, process 600 may involve processor 412 transmitting the first PHR and the second PHR to the network node.

In some implementations, in an event that the first PUSCH transmission is an actual PUSCH transmission corresponding to the first indicated TCI state and the second PUSCH transmission is a reference PUSCH transmission, process 600 may involve processor 412 determining the first PHR associated with the first indicated TCI state for the actual PUSCH transmission corresponding to the first indicated TCI state. Process 600 may further involve processor 412 determining the second PHR associated with the second indicated TCI state for the reference PUSCH transmission based on at least one power control parameter and a pathloss reference signal associated with the second indicated TCI state.

In some implementations, in an event that the first PUSCH transmission is a reference PUSCH transmission and the second PUSCH transmission is an actual PUSCH transmission corresponding to the second indicated TCI state, process 600 may involve processor 412 determining the first PHR associated with the first indicated TCI state for the reference PUSCH transmission based on at least one power control parameter and a pathloss reference signal associated with the first indicated TCI state. Process 600 may further involve processor 412 determining the second PHR associated with the second indicated TCI state for the actual PUSCH transmission corresponding to the second indicated TCI state.

In some implementations, in an event that both the first PUSCH transmission and the second PUSCH transmission are an actual PUSCH transmission corresponding to both the first indicated TCI state and the second indicated TCI state, process 600 may involve processor 412 determining the first PHR associated with the first indicated TCI state for the actual PUSCH transmission corresponding to both the first indicated TCI state and the second indicated TCI state. Process 600 may further involve processor 412 determining the second PHR associated with the second indicated TCI state for the actual PUSCH transmission corresponding to both the first indicated TCI state and the second indicated TCI state.

In some implementations, in an event that the first PUSCH transmission is a first reference PUSCH transmission and the second PUSCH transmission is a second reference PUSCH transmission, process 600 may involve processor 412 determining the first PHR associated with the first indicated TCI state for the first reference PUSCH transmission based on based on at least one power control parameter and a pathloss reference signal associated with the first indicated TCI state. Process 600 may further involve processor 412 determining the second PHR associated with the second indicated TCI state for the second reference PUSCH transmission based on based on at least one power control parameter and a pathloss reference signal associated with the second indicated TCI state.

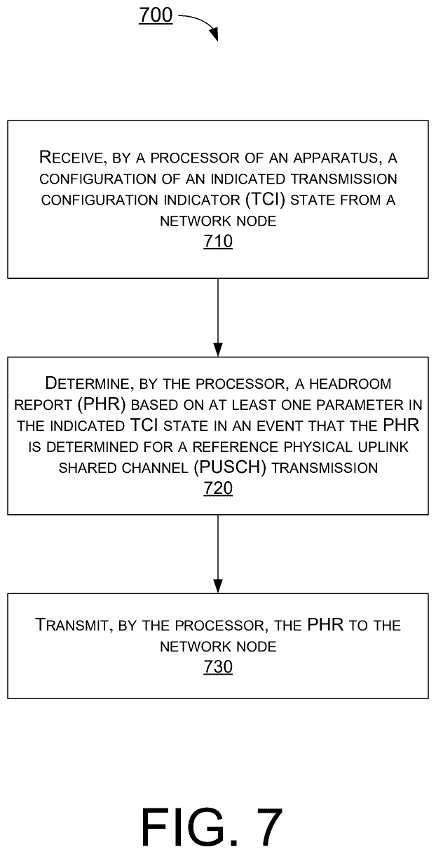

FIG. 7 illustrates an example process 700 under schemes in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to PHR for MTRP operation in mobile communications. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in communication apparatus 410 as well as any variations thereof. Solely for illustrative purposes and without limiting the scope, process 700 is described below in the context of communication apparatus 410 as a UE and network apparatus 420 as a network node (e.g., TRP). Process 700 may begin at block 710.

At block 710, process 700 may involve processor 412 of communication apparatus 410, implemented in or as a UE, receiving a configuration of an indicated TCI state from a network node. Process 700 may proceed from block 710 to block 720.

At block 720, process 700 may involve processor 412 determining a PHR based on at least one parameter in the indicated TCI state in an event that the PHR is determined for a reference PUSCH transmission. Process 700 may proceed from block 720 to block 730.

At block 730, process 600 may involve processor 412 transmitting the PHR to the network node.

In some implementations, the indicated TCI state may comprise a first indicated TCI state. Process 700 may involve processor 412 determining the PHR based on at least one power control parameter and a pathloss reference signal associated with the first indicated TCI state.

In some implementations, the indicated TCI state may comprise a second indicated TCI state. Process 700 may involve processor 412 determining the PHR based on at least one power control parameter and a pathloss reference signal associated with the second indicated TCI state.

In some implementations, the indicated TCI state may comprise a first indicated TCI state and a second indicated TCI state. Process 700 may involve processor 412 determining a first PHR based on at least on power control parameter and a pathloss reference signal associated with the first indicated TCI state in an event that the first PHR is determined for a reference PUSCH transmission associated a first SRS resource set. Process 700 may further involve processor 412 determining a second PHR based on at least on power control parameter and a pathloss reference signal associated with the second indicated TCI state in an event that the second PHR is determined for a reference PUSCH transmission associated a second SRS resource set.

In some implementations, process 700 may involve processor 412 receiving a configuration of a first SRS resource set from the network node. Process 700 may also involve processor 412 determining a first PHR based on an actual PUSCH transmission in an event that the first PHR is determined for an actual PUSCH repetition of a PUSCH transmission associated with the first SRS resource set. Process 700 may further involve processor 412 transmitting the first PHR to the network node.

In some implementations, process 700 may involve processor 412 receiving a configuration of a second SRS resource set from the network node. Process 700 may also involve processor 412 determining a second PHR based on an actual PUSCH transmission in an event that the second PHR is determined for an actual PUSCH repetition associated with the second SRS resource set. Process 700 may further involve processor 412 transmitting the second PHR to the network node.

In some implementations, the indicated TCI state may comprise a first indicated TCI state and a second indicated TCI state. Process 700 may involve processor 412 determining a first PHR associated with the first indicated TCI state based on an actual PUSCH transmission in an event that the first PHR is determined for an actual PUSCH transmission applying only the first indicated TCI state. Process 700 may also involve processor 412 transmitting the first PHR to the network node. Process 700 may further involve processor 412 determining a second PHR associated with the second indicated TCI state based on at least one parameter in the second indicated TCI state in an event that the second PHR is determined for a reference PUSCH transmission.

In some implementations, the indicated TCI state may comprise a first indicated TCI state and a second indicated TCI state. Process 700 may involve processor 412 determining a second PHR associated with the second indicated TCI state based on an actual PUSCH transmission in an event that the second PHR is determined for an actual PUSCH transmission applying only the second indicated TCI state. Process 700 may also involve processor 412 transmitting the second PHR to the network node. Process 700 may further involve processor 412 determining a first PHR associated with the first indicated TCI state based on at least one parameter in the first indicated TCI state in an event that the first PHR is determined for a reference PUSCH transmission.

In some implementations, the indicated TCI state may comprise a first indicated TCI state and a second indicated TCI state. Process 700 may involve processor 412 determining a first PHR associated with the first indicated TCI state based on an actual PUSCH transmission in an event that the first PHR is determined for an actual PUSCH transmission applying both the first indicated TCI state and the second indicated TCI state. Process 700 may also involve processor 412 determining a second PHR associated with the second indicated TCI state based on an actual PUSCH transmission in an event that the second PHR is determined for an actual PUSCH transmission applying both the first indicated TCI state and the second indicated TCI state. Process 700 may further involve processor 412 transmitting the first PHR and the second PHR to the network node.

In some implementations, the indicated TCI state may comprise a first indicated TCI state and a second indicated TCI state. Process 700 may involve processor 412 determining a first PHR associated with the first indicated TCI state based on at least one parameter in the first indicated TCI state in an event that the first PHR is determined for a first reference PUSCH transmission. Process 700 may also involve processor 412 determining a second PHR associated with the second indicated TCI state based on at least one parameter in the second indicated TCI state in an event that the second PHR is determined for a second reference PUSCH transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration of a two power headroom report (PHR) mode and two sounding reference signal (SRS) resource sets from a network node;
determining, by the processor, a first PHR for a first physical uplink shared channel (PUSCH) transmission associated with one SRS resource set;
determining, by the processor, a second PHR for a second PUSCH transmission associated with the other SRS resource set; and
transmitting, by the processor, the first PHR and the second PHR to the network node.

2. The method of claim 1, wherein the first PUSCH transmission is an actual PUSCH repetition associated with one SRS resource set starting earliest in a slot, and no PUSCH repetition associated with the other SRS resource set is transmitted by the apparatus in the slot.

3. The method of claim 2, wherein the second PUSCH transmission is a reference PUSCH transmission associated with the other SRS resource set, and wherein the determining of the second PHR for the reference PUSCH transmission associated with the other SRS resource set comprises determining the second PHR based on at least one power control parameter and a pathloss reference signal associated with a first indicated transmission configuration indicator (TCI) state in an event that the other SRS resource set is a first SRS resource set.

4. The method of claim 2, wherein the second PUSCH transmission is a reference PUSCH transmission associated with the other SRS resource set, and wherein the determining of the second PHR for the reference PUSCH transmission associated with the other SRS resource set comprises determining the second PHR based on at least one power control parameter and a pathloss reference signal associated with a second indicated transmission configuration indicator (TCI) state in an event that the other SRS resource set is a second SRS resource set.

5. The method of claim 1, wherein the first PUSCH transmission is a reference PUSCH transmission associated with a first SRS resource set and the second PUSCH transmission is a reference PUSCH transmission associated with a second SRS resource set, and wherein the determining of the first PHR and the determining of the second PHR comprises:
determining, by the processor, the first PHR for the reference PUSCH transmission associated with the first SRS resource set based on at least on power control parameter and a pathloss reference signal associated with a first indicated transmission configuration indicator (TCI) state; and
determining, by the processor, the second PHR for the reference PUSCH transmission associated with the second SRS resource set based on at least one power control parameter and a pathloss reference signal associated with a second indicated TCI state.

6. A method, comprising:
receiving, by a processor of an apparatus, a configuration of a two power headroom report (PHR) mode, two sounding reference signal (SRS) resource sets, a first indicated transmission configuration indicator (TCI) state, a second indicated TCI state and a multi-panel scheme from a network node;
determining, by the processor, a first PHR associated with the first indicated TCI state for a first physical uplink shared channel (PUSCH) transmission and a second PHR associated with the second indicated TCI state for a second PUSCH transmission; and
transmitting, by the processor, the first PHR and the second PHR to the network node.

7. The method of claim 6, wherein in an event that the first PUSCH transmission is an actual PUSCH transmission corresponding to the first indicated TCI state and the second PUSCH transmission is a reference PUSCH transmission, the determining comprises:
determining, by the processor, the first PHR associated with the first indicated TCI state for the actual PUSCH transmission corresponding to the first indicated TCI state; and
determining, by the processor, the second PHR associated with the second indicated TCI state for the reference PUSCH transmission based on at least one power control parameter and a pathloss reference signal associated with the second indicated TCI state.

8. The method of claim 6, wherein in an event that the first PUSCH transmission is a reference PUSCH transmission and the second PUSCH transmission is an actual PUSCH transmission corresponding to the second indicated TCI state, the determining comprises:
determining, by the processor, the first PHR associated with the first indicated TCI state for the reference PUSCH transmission based on at least one power control parameter and a pathloss reference signal associated with the first indicated TCI state; and
determining, by the processor, the second PHR associated with the second indicated TCI state for the actual PUSCH transmission corresponding to the second indicated TCI state.

9. The method of claim 6, wherein in an event that both the first PUSCH transmission and the second PUSCH transmission are an actual PUSCH transmission corresponding to both the first indicated TCI state and the second indicated TCI state, the determining comprises:
determining, by the processor, the first PHR associated with the first indicated TCI state for the actual PUSCH transmission corresponding to both the first indicated TCI state and the second indicated TCI state; and
determining, by the processor, the second PHR associated with the second indicated TCI state for the actual PUSCH transmission corresponding to both the first indicated TCI state and the second indicated TCI state.

10. The method of claim 6, wherein in an event that the first PUSCH transmission is a first reference PUSCH transmission and the second PUSCH transmission is a second reference PUSCH transmission, the determining comprises:
determining, by the processor, the first PHR associated with the first indicated TCI state for the first reference PUSCH transmission based on based on at least one power control parameter and a pathloss reference signal associated with the first indicated TCI state; and
determining, by the processor, the second PHR associated with the second indicated TCI state for the second reference PUSCH transmission based on based on at least one power control parameter and a pathloss reference signal associated with the second indicated TCI state.

11. An apparatus, comprising:
a transceiver which, during operation, wirelessly communicates with at least one network node; and
a processor communicatively coupled to the transceiver such that, during operation, the processor performs operations comprising:
receiving, via the transceiver, a configuration of a two power headroom report (PHR) mode and two sounding reference signal (SRS) resource sets from the network node;
determining a first PHR for a first physical uplink shared channel (PUSCH) transmission associated with one SRS resource set;
determining a second PHR for a second PUSCH transmission associated with the other SRS resource set; and
transmitting, via the transceiver, the first PHR and the second PHR to the network node.

12. The apparatus of claim 11, wherein the first PUSCH transmission is an actual PUSCH repetition associated with one SRS resource set starting earliest in a slot, and no PUSCH repetition associated with the other SRS resource set is transmitted by the apparatus in the slot.

13. The apparatus of claim 12, wherein the second PUSCH transmission is a reference PUSCH transmission associated with the other SRS resource set, and wherein, in determining the second PHR for the reference PUSCH transmission associated with the other SRS resource set, the processor determines the second PHR based on at least one power control parameter and a pathloss reference signal associated with a first indicated transmission configuration indicator (TCI) state in an event that the other SRS resource set is a first SRS resource set.

14. The apparatus of claim 12, wherein the second PUSCH transmission is a reference PUSCH transmission associated with the other SRS resource set, and wherein, in determining the second PHR for the reference PUSCH transmission associated with the other SRS resource set, the processor determines the second PHR based on at least one power control parameter and a pathloss reference signal associated with a second indicated transmission configuration indicator (TCI) state in an event that the other SRS resource set is a second SRS resource set.

15. The apparatus of claim 11, wherein the first PUSCH transmission is a reference PUSCH transmission associated with a first SRS resource set and the second PUSCH transmission is a reference PUSCH transmission associated with a second SRS resource set, and wherein, in determining the first PHR and determining of the second PHR, the performs operations comprising:
determining the first PHR for the reference PUSCH transmission associated with the first SRS resource set based on at least on power control parameter and a pathloss reference signal associated with a first indicated transmission configuration indicator (TCI) state; and
determining the second PHR for the reference PUSCH transmission associated with the second SRS resource set based on at least one power control parameter and a pathloss reference signal associated with a second indicated TCI state.

16. An apparatus, comprising:
a transceiver which, during operation, wirelessly communicates with at least one network node; and
a processor communicatively coupled to the transceiver such that, during operation, the processor performs operations comprising:
receiving, via the transceiver, a configuration of a two power headroom report (PHR) mode, two sounding reference signal (SRS) resource sets, a first indicated transmission configuration indicator (TCI) state, a second indicated TCI state and a multi-panel scheme from the network node;
determining a first PHR associated with the first indicated TCI state for a first physical uplink shared channel (PUSCH) transmission and a second PHR associated with the second indicated TCI state for a second PUSCH transmission; and
transmitting, via the transceiver, the first PHR and the second PHR to the network node.

17. The apparatus of claim 16, wherein in an event that the first PUSCH transmission is an actual PUSCH transmission corresponding to the first indicated TCI state and the second PUSCH transmission is a reference PUSCH transmission, in determining, the processor performs operations comprising:
determining the first PHR associated with the first indicated TCI state for the actual PUSCH transmission corresponding to the first indicated TCI state; and
determining the second PHR associated with the second indicated TCI state for the reference PUSCH transmission based on at least one power control parameter and a pathloss reference signal associated with the second indicated TCI state.

18. The apparatus of claim 16, wherein in an event that the first PUSCH transmission is a reference PUSCH transmission and the second PUSCH transmission is an actual PUSCH transmission corresponding to the second indicated TCI state, in determining, the processor performs operations comprising:
determining the first PHR associated with the first indicated TCI state for the reference PUSCH transmission based on at least one power control parameter and a pathloss reference signal associated with the first indicated TCI state; and
determining the second PHR associated with the second indicated TCI state for the actual PUSCH transmission corresponding to the second indicated TCI state.

19. The apparatus of claim 16, wherein in an event that both the first PUSCH transmission and the second PUSCH transmission are an actual PUSCH transmission corresponding to both the first indicated TCI state and the second indicated TCI state, in determining, the processor performs operations comprising:
determining the first PHR associated with the first indicated TCI state for the actual PUSCH transmission corresponding to both the first indicated TCI state and the second indicated TCI state; and
determining the second PHR associated with the second indicated TCI state for the actual PUSCH transmission corresponding to both the first indicated TCI state and the second indicated TCI state.

20. The apparatus of claim 16, wherein in an event that the first PUSCH transmission is a first reference PUSCH transmission and the second PUSCH, transmission is a second reference PUSCH transmission, in determining, the processor performs operations comprising:
determining the first PHR associated with the first indicated TCI state for the first reference PUSCH transmission based on based on at least one power control parameter and a pathloss reference signal associated with the first indicated TCI state; and
determining the second PHR associated with the second indicated TCI state for the second reference PUSCH transmission based on based on at least one power control parameter and a pathloss reference signal associated with the second indicated TCI state.
